(19) United States
(12) Patent Application Publication
(10) Pub. No.: US 2023/0411026 A1
(43) Pub. Date: Dec. 21, 2023

(54) NUCLEAR POWER PLANT COMPRISING A SYSTEM FOR DEGASIFICATION OF A GASEOUS LIQUID

(71) Applicant: FRAMATOME GmbH, ERLANGEN (DE)

(72) Inventors: Martin BENECKE, NIEDERGÖRSDORF (DE); Marco BEWER, OESDORF (DE); Jörg NIEDERMEYER, WASSERTRÜDINGEN (DE)

(21) Appl. No.: 18/037,240

(22) PCT Filed: Nov. 16, 2020
(86) PCT No.: PCT/EP2020/082288

§ 371 Date: May 16, 2023

(51) Int. Cl. G21C 19/307; B01D 19/00

(52) U.S. Cl. CPC G21C 19/307; B01D 19/0078; B01D 19/0005; B01D 19/0047; B01D 19/0057

(57) ABSTRACT

A nuclear power plant comprises a system for degasification of a gaseous liquid, the system comprising a separation vessel having at least one outer wall delimiting an inner volume and configured for separating gas from the gaseous liquid, at least one inlet adapted to introduce the gaseous liquid into the inner volume, at least one gas suction line attached to the separation vessel and being adapted to discharge the separated gas from the inner volume, at least one outlet adapted to discharge a degassed liquid from the inner volume, and a sonotrode cluster configured to expose the gaseous liquid to ultrasonic waves.

The present disclosure relates to a nuclear power plant comprising a system for degasification.

### BACKGROUND

The present disclosure relates to the field of nuclear power plants, in particular to the operation of nuclear power plants.

In a nuclear power plant, it may be desired to remove gases from a gaseous liquid for various reasons. For example, it may be desired to separate gases from a reactor coolant, in which such gases are dissolved. Such a method is generally called ‘degasification’ or ‘degassing’.

In the case where the gaseous liquid is a reactor coolant, removal of oxygen for example allows avoiding corrosion inside a piping system in which the reactor coolant circulates. According other examples, hydrogen may be removed in case of a shutdown of the nuclear power plant, or radionuclides may be removed prior to maintenance operations on the nuclear power plant.

There exist systems for removing gases from a gaseous liquid in which an ultrasonic emitter placed under a reactor containing the liquid to be treated. The emitter thus transmits ultrasonic waves through a wall of the reactor into the liquid to be treated so as to allow degassing of the gaseous fluid.

### SUMMARY

However, such systems are not completely satisfying. For example, not all the liquid present in the reactor may penetrated by the ultrasounds, and the elimination of compounds is thus not satisfying. Alternatively, in order to penetrate all the liquid, only a small amount of liquid may be present in the reactor, and thus only a small amount of liquid may be treated in a given time to eliminate the organic compounds.

Therefore, it is an object of the present disclosure to provide a nuclear power plant comprising a system for degasification of a gaseous liquid, which allows a very efficient degasification.

According to one aspect, the present disclosure concerns a nuclear power plant comprising a system for degasification of a gaseous liquid, the system comprising:
a separation vessel having at least one outer wall delimiting an inner volume and configured for separating gas from the gaseous liquid,
at least one inlet adapted to introduce the gaseous liquid into the inner volume,
at least one gas suction line attached to the separation vessel and being adapted to discharge the separated gas from the inner volume, and
at least one outlet adapted to discharge a degassed liquid from the inner volume,
a sonotrode cluster configured to expose the gaseous liquid to ultrasonic waves,

the sonotrode cluster comprising at least one sonotrode extending from the outer wall of the separation vessel into the inner volume.

This degasification system allows to penetrate the whole gaseous liquid, because the at least one sonotrode is in the inner volume of the separation vessel from which the gas is discharged. For example, as no outer wall of the vessel is positioned between the at least one sonotrode and the gaseous liquid, the gaseous liquid is penetrated directly, and gas is released from the gaseous liquid in a reliable manner, in particular without attenuation of the ultrasonic waves for example by the wall.

Therefore, the degasification allows efficient degasification of a gaseous liquid in a nuclear power plant.

Also, as the at least one sonotrode extends into the inner volume of the separation vessel from which the separated gas is to be discharged, the separation of the gas from the gaseous liquid can take place very close to the evacuation of the gas. This allows to avoid or at least to reduce the amount of gas dissolving back into the liquid prior to its evacuation from the separation vessel. This degasification system therefore allows for a very efficient degasification, because a high amount of gas is separated from the liquid and evacuated.

Further embodiments may relate to one or more of the following features, which may be combined in any technical feasible combination:
the gaseous liquid comprises water and at least one gas and related nuclides, the gas being chosen from the list constituted by hydrogen; oxygen; nitrogen; xenon, and krypton;
the nuclear power plant comprises a primary reactor coolant circuit and a secondary reactor coolant circuit, at least the inlet being fluidically connected to the primary reactor coolant circuit or to the secondary reactor coolant circuit;
the at least one sonotrode extends perpendicularly relative to the outer wall from the outer wall into the inner volume;
the outer wall comprises a lateral wall, and comprises furthermore an upper wall and a lower wall connected by the lateral wall;
the at least one sonotrode extends from the lateral wall;
the inlet and the outlet are arranged tangentially with respect to the lateral wall of the separation vessel so as to generate a centrifugal flow of the gaseous liquid in the separation vessel;
the inlet comprises at least one spray nozzle configured to disperse the gaseous liquid in the form of droplets into the inner volume;
the at least one sonotrode is arranged at least partially inside the spray nozzle;
the at least one spray nozzle forms the at least one sonotrode;
the degasification system comprises a grid structure arranged in the inner volume of the separation vessel;
the degasification system comprises a stripping gas device configured for introducing a stripping gas into the inner volume;
the degasification system comprises a recombinator configured to receive the separated gas, and to reintroduce at least a part of the separated gas into the separation vessel, for example combined with another gas;
the sonotrode cluster is arranged such that the gaseous liquid in the inner volume is penetrated homogenously.

According to another aspect, the present disclosure concerns a nuclear power plant comprising a system for degasification of a gaseous liquid, the system comprising:
a separation vessel having at least one outer wall delimiting an inner volume,
at least one inlet adapted to introduce the gaseous liquid into the inner volume,
at least one gas suction line attached to the separation vessel and being adapted to discharge separated gas from the inner volume, and
at least one outlet adapted to discharge a degassed liquid from the inner volume,
a sonotrode cluster configured to expose the gaseous liquid to ultrasonic waves, the at least one inlet comprising at least one spray nozzle configured to disperse the gaseous liquid in the form of droplets into the inner volume.

Further embodiments may relate to one or more of the following features, which may be combined in any technical feasible combination:
the sonotrode cluster comprises at least one sonotrode arranged upstream of the separation vessel;
the sonotrode cluster comprises at least one sonotrode extending from the outer wall of the separation vessel into the inner volume;
the at least one sonotrode extending from the outer wall of the separation vessel is arranged at least partially inside the spray nozzle;
the at least one spray nozzle forms the at least one sonotrode extending from the outer wall of the separation vessel.

### BRIEF SUMMARY OF THE DRAWINGS

These features and advantages of the present disclosure will be further explained in the following description, given only as a non-limiting example, and with reference to the attached drawings, on which:

FIG. 1 is a schematic partial sectional view of a part of a nuclear power plant comprising a system for degasification of a gaseous liquid according to a first embodiment of the present disclosure;

FIG. 2 is a schematic sectional view analog to FIG. 1 according to a second embodiment of the present disclosure;

FIG. 3 is a schematic sectional view analog to FIG. 1 according to a first example of a third embodiment of the present disclosure;

FIG. 4 is a schematic sectional view analog to FIG. 3 according to a second example of the third embodiment, and

FIG. 5 is a schematic sectional view analog to FIG. 3 according to a third example of the third embodiment.

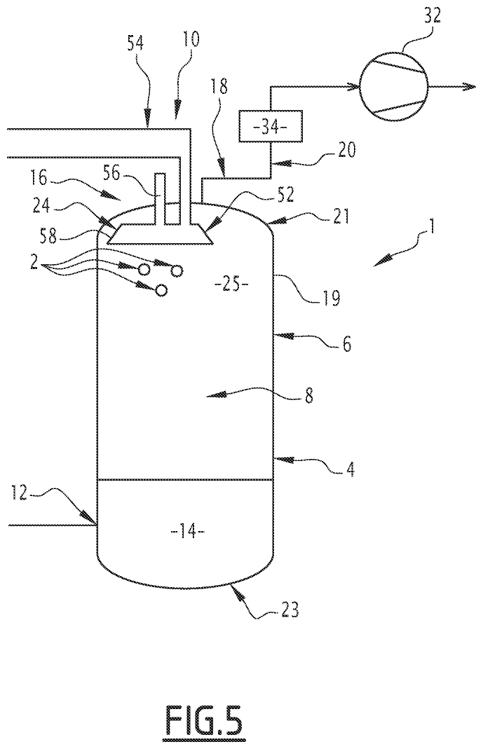

### DETAILED DESCRIPTION

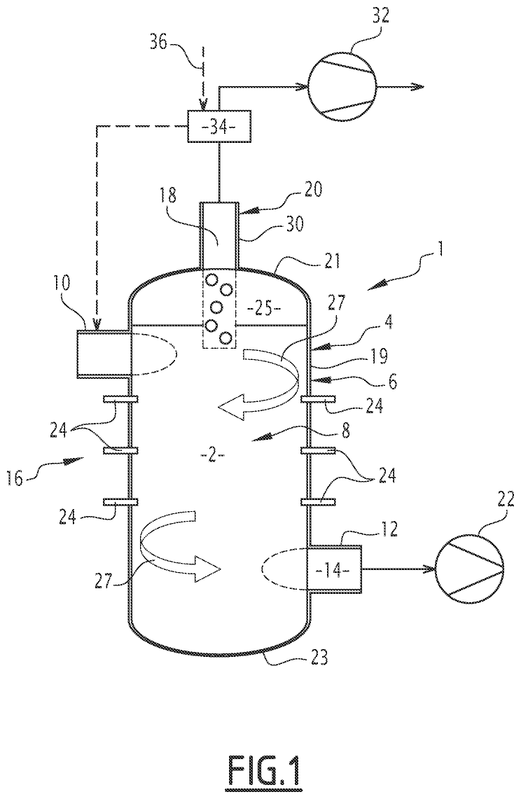

With reference to FIG. 1, a nuclear power plant according to a first embodiment comprises a system for degasification 1 of a gaseous liquid 2. In the following, this system 1 is called “degasification system”.

The degasification system 1 comprises a separation vessel 4 having an outer wall 6 delimiting an inner volume 8, at least one inlet 10 adapted to introduce the gaseous liquid 2 into the inner volume 8 and at least one outlet 12 adapted to discharge a degassed liquid 14 from the inner volume 8.

The degasification system 1 also comprises a sonotrode cluster 16 configured to expose the gaseous liquid 2 contained in the inner volume 8 of the separation vessel 4 to ultrasonic waves.

The degasification system 1 further comprises at least one gas suction line 20 attached to the separation vessel 4 and being adapted to discharge separated gas 18 from the inner volume 8.

For example, the nuclear power plant comprises, not shown, a primary reactor coolant circuit, a secondary reactor coolant circuit and a nuclear reactor core. The nuclear power plant comprises for example a light water reactor, in particular a Pressurized Water Rector (PWR) or a Boiling Water Reactor (BWR) or a heavy-water reactor, such as the CANDU (Canada Deuterium Uranium) reactor.

For example, the primary reactor coolant circuit is fluidically connected to the nuclear reactor core of the nuclear power plant so as to circulate a primary coolant. The secondary reactor coolant circuit is fluidically separated from the primary coolant circuit. The secondary reactor coolant circuit is in particular configured to circulate a secondary coolant so as to exchange heat with the primary coolant.

In all the description, a “gaseous liquid” is a liquid containing dissolved gas therein. The liquid is, for example, a coolant for cooling, directly or indirectly, a nuclear reactor core of the nuclear power plant. In particular, the coolant comprises water.

For example, the gaseous liquid 2 to be degassed is the primary coolant of the primary reactor coolant circuit or the secondary coolant of the secondary reactor coolant circuit.

In the case where the gaseous liquid 2 is the primary coolant, the inlet 10 and/or the outlet 12, is/are fluidically connected to the primary reactor coolant circuit. In particular, the nuclear power plant is configured to circulate the primary coolant through the nuclear reactor core, then via the inlet 10 into the separation vessel 4, and via the outlet 12 again then back to the nuclear reactor core.

According to another example, the inlet 10 and/or the outlet 12 is/are fluidically connected to the secondary reactor coolant circuit. In this case, the nuclear power plant is configured to circulate the secondary coolant through the secondary reactor coolant circuit, then via the inlet 10 into the separation vessel 4, and via the outlet 12 again through the secondary reactor coolant circuit.

According to other examples, the gaseous liquid 2 is any other gaseous liquid than a primary or secondary coolant, intended to circulate in the nuclear power plant.

According to an example, the gaseous liquid 2 comprises a quantity of gas lower than a saturation point of the liquid. In this case, the gaseous liquid 2 is designated as an undersaturated liquid.

The gas comprised in the gaseous liquid 2 comprises for example one of the following gases, and is preferably constituted by one of the following gases: hydrogen, oxygen, nitrogen, xenon, and krypton. According to an example, the gaseous liquid 2 comprises also nuclides corresponding to the gas(es).

For example, the gas comprised in the gaseous liquid 2 comprises a noble gas, and is preferably constituted by a noble gas, such as helium (He), neon (Ne), argon (Ar), krypton (Kr), xenon (Xe), or the radioactive radon (Rn).

According to some embodiments, the degasification system 1 comprises at least one extractor pump 22 to extract the degassed liquid 14 from the separation vessel 4. The extractor pump 22 is for example arranged so as to circulate the degassed liquid 14 from the outlet 12 to the nuclear reactor core, and then to the inlet 10.

According to other embodiments, the degasification system 1 does not comprise such a pump. In this case, the outlet 12 is for example provided in a lower part of the separation vessel 4 so as to allow extraction of the degassed liquid 14 from the separation vessel 4.

The whole degasification system 1 is preferably designed to operate continuously with a continuous inflow of gaseous liquid 2 and a continuous outflow of separated gas 18 and degassed liquid 14.

According to one embodiment, the degasification system 1 is designed as a movable system, and for example comprises transport rollers (not shown). As an alternative, the degasification system 1 is a stationary installation.

The separation vessel 4 or tank is in particular delimited by the outer wall 6. The outer wall 6 comprises for example a plurality of segments. For example, the outer wall 6 comprises a lateral wall 19, which is for example a vertical wall. The outer wall 6 comprises furthermore for example an upper wall 21 and a lower wall 23, respectively at its upper and lower ends, connected by the lateral wall 19.

The vertical wall extends in a vertical direction when the degasification system 1 is in operation.

In particular, the inner volume 8 of the separation vessel 4 has a cylindrical shape, delimited laterally with the lateral wall 19 and by the upper wall 21 and lower wall 23 at its top and bottom respectively. For example, the lateral wall 19 has a round shape so as to be rotationally symmetric with respect to an axis traversing a center of the separation vessel 4.

The separation vessel 4 is designed to contain the gaseous liquid for a treatment by the sonotrode cluster 16 in the inner volume 8, and for a separation of the separated gas 18 from the gaseous liquid 2.

The separation vessel 4 is designed to be filled with the gaseous liquid 2 entering from the inlet 10 up to a given design filling level during flow-through operation. The separation vessel 4 is further designed to discharge the degassed liquid 14 via the outlet 12 as liquid outflow or stream. In particular, the inlet 10 is arranged so as to discharge the gaseous liquid 2 in a region of the inner volume 8 below a gas space 25 of said inner volume 8.

The sonotrode cluster 16 is configured to form cavitation bubbles of the gas dissolved in the gaseous liquid 2 due to the ultrasonic application of energy inside the inner volume 8. These cavitation bubbles are typically very small, and gather into larger bubbles and rise to the surface of the liquid so as to allow extraction of the separated gas 18 from the separation vessel 4 via the gas suction line 20.

The sonotrode cluster 16 is in particular arranged in the separation vessel 4 such that the gaseous liquid 2 in the inner volume 8 is penetrated homogenously by the ultrasonic waves emitted by the sonotrodes 24 of the sonotrode cluster 16.

By the expression “homogenously”, it is in particular understood that, throughout the liquid contained in the separation vessel 4, the intensity of the ultrasonic waves is superior than a predetermined lower threshold, and inferior than a predetermined upper threshold.

The sonotrode cluster 16 comprises at least one sonotrode 24 extending from the outer wall 6 of the separation vessel 4 into the inner volume 8. In this context, a sonotrode 24 is an ultrasonic oscillator of the sonotrode cluster 16.

In general, a sonotrode 24 is a device that creates ultrasonic vibrations and applies vibrational energy to a gas, liquid, solid or tissue. A sonotrode usually consists of a stack of piezoelectric transducers attached to a tapering metal rod. The end of the rod is applied to the working material. An alternating current oscillating at ultrasonic frequency is applied by a separate power supply unit to the piezoelectric transducers. The current causes them to expand and contract. Advantageously, the frequency of the current is chosen to be the resonant frequency of the tool, so the entire sonotrode acts as a half-wavelength resonator, vibrating lengthwise with standing waves at its resonant frequency. The standard frequencies used with ultrasonic sonotrodes range from 20 kHz to 70 kHz. Usually, the amplitude of the vibration is small, about 13 to 130 micrometers.

The or each sonotrode 24 applies vibrational energy to the gaseous liquid 2 flowing through or being present in the inner volume 8. This leads to cavitation, a phenomenon in which rapid changes of pressure in the liquid lead to local vaporization and thus to the formation of small vapor-filled cavities. In other words, the dissolved gas gets entrapped into micro gas bubbles which can easily be separated from the gaseous liquid 2 inside the inner volume 8.

Depending on the operating conditions and the objectives of operation, if more than one sonotrode 24 is arranged in the separation vessel 4, some of the sonotrodes 24 may be switched off into a non-active state.

For example, as visible in particular in FIG. 1, the sonotrode cluster 16 comprises six sonotrodes 24. Other examples, the sonotrode cluster 16 comprises one, two or more than two sonotrodes 24.

According to some embodiments, the sonotrode(s) 24 extend(s) perpendicularly from the outer wall 6, in particular from the lateral wall 19, into the inner volume 8. This is in particular visible in the example of FIG. 1.

In the case where the sonotrode cluster 16 comprises more than one sonotrode 24, the sonotrodes 24 for example extend parallel one to another.

The sonotrode(s) 24 preferably extend(s) in a peripheral part of the inner volume 8. The peripheral part of the inner volume 8 is for example a part of the inner volume 8 in which each position has a distance to the later wall 19 less than 40%, preferably less than 20%, of a maximum horizontal diameter of the separation vessel 4.

This arrangement allows obtaining a separation of gas from the gaseous liquid 2 in the peripheral part of the inner volume 8.

The treatment of the gaseous liquid 2 by the sonotrode cluster 16 allows a degasification at low cost, which is furthermore energy-efficient, space-saving, presenting a low-maintenance, easy installation and operation, a modular design, and is expandable or scalable on demand.

For example, the inlet 10 and/or the outlet 12 are arranged tangentially with respect to the lateral wall 19 of the separation vessel 4 so as to generate a centrifugal flow of the gaseous liquid 2 inside the inner volume 8, shown by the arrows 27 in FIG. 1.

By the expression “arranged tangentially with respect to the lateral wall 19”, it is understood that the inlet 10 and/or the outlet 12 is arranged such that a flow direction of a fluid traversing the inlet 10 or the outlet 12 is substantially parallel to the lateral wall 19 at a position where the inlet 10 or the outlet 12 is arranged.

According to an alternative, or as an option, the degasification system 1 comprises a rotation device configured to generate the centrifugal flow of the gaseous liquid 2, not shown, arranged inside the inner volume 8.

The centrifugal flow of the gaseous liquid 2 allows to improve the extraction of gas from the gaseous liquid 2, because the medium having a lower density is directed to the center of the inner volume 8. Thus, small gas bubbles (described below) formed inside the gaseous liquid 2 by the sonotrode cluster 16 are directed to the center of the inner volume 8, where they gather together to bigger gas bubbles which are extracted easily via the gas suction line 20.

This effect is particularly important in an arrangement combining the sonotrode cluster 16 together with the inlet 10 and the outlet 12 being arranged tangentially so as to obtain the centrifugal flow.

The gas suction line 20 comprises an outlet tube 30 connected to inner volume 8, in particular to the gas space 25, of the separation vessel 4.

The gas suction line 20 may further comprise a vacuum pump 32 configured to pump the separated gas 18 for example to a gas waste system.

Optionally or as an alternative, the suction line 20 further comprises a recombinator 34 configured to receive the separated gas 18, and to reintroduce at least a part of the separated gas 18 into the separation vessel 4. In an example, the recombinator 34 is configured to combine the part of the separated gas 18 with a recombination gas. In the example shown in FIG. 1, the recombination gas is supplied to the recombinator 34 via a provision line 36. The recombination gas is, for example, oxygen.

The recombinator 34 is configured to operate in particular depending on an operational state of the nuclear power plant. For example, during a first operational state, the recombinator 34 is configured to receive the separated gas 18 in the form of hydrogen and to re-introduce at least a part of this hydrogen, possibly combined with oxygen as a recombination gas received via the provision line 36, into the separation vessel 4. This allows for example to maintain a predefined hydrogen level in the gaseous liquid 2.

During a second operational state of the nuclear power plant, the recombinator 34 does not introduce hydrogen from the separation vessel 4.

The capability to operate the recombinator according to different operational states allows for example avoiding an accumulation of hydrogen in the degasification system 1 and thus improves the operational safety.

For example, the nuclear power plant in the second operational state, and in particular the recombinator 34, is configured to, inject air and/or oxygen and nitrogen into the gaseous liquid 2 in a ratio which prevents explosion and allows for example a stoichiometric reaction. For example, the recombinator 34 is configured to receive an inflow containing hydrogen, oxygen and nitrogen and to provide an outflow containing water and nitrogen.

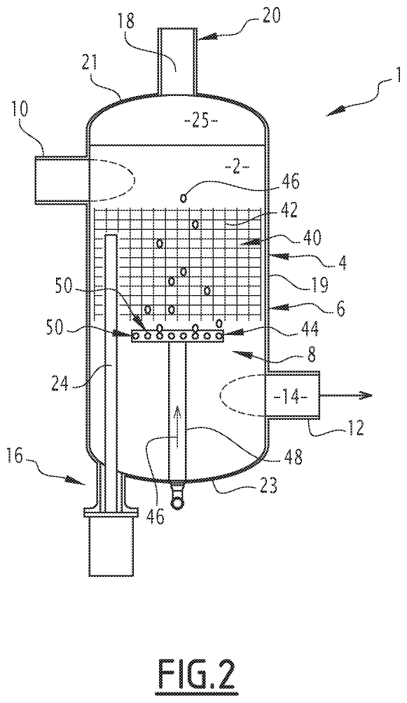

With reference to FIG. 2, a second embodiment of the nuclear power plant comprising the degasification system 1 is shown. The references of the corresponding parts of the embodiment shown in FIG. 1 are the same. Only the differences are described hereafter.

The sonotrode cluster 16 comprises at least one sonotrode 24 extending from the lower wall 23. According to an alternative (not shown), the at least one sonotrode 24 extends from the upper wall 21.

Even if not shown in FIG. 2, the suction line 20 of the nuclear power plant 1 according to the second embodiment may be identical to the one described above. It may in particular also include the optional recombinator 34 and/or the extractor pump 22 described with reference to FIG. 1.

In this embodiment, the degasification system 1 may further comprise a grid structure 40 arranged in the inner volume 8 of the separation vessel 4. The grid structure 40 for example comprises a plurality of bars 42 extending in parallel and perpendicular one to another.

For example, the grid structure 40 is configured to bond micro bubbles generated by the sonotrode cluster 16 and to form larger bubbles to be degassed from the separation vessel 4.

The grid structure 40 is furthermore for example configured to reduce turbulences of the gaseous liquid 2 inside the separation vessel 4.

For example, the grid structure is optimized to have a high surface area and/or to withstand impact related to fluid parameters for fluids used in nuclear power plants.

According to an example, the at least one sonotrode 24 in the second embodiment extends throughout a part of the grid structure 40.

The degasification system 1 furthermore for example comprises a stripping gas device 44 configured for introducing a stripping gas 46 into the inner volume 8. The stripping gas is, for example, chosen among air, nitrogen, and hydrogen.

The stripping gas 46 allows separating gas from the gaseous liquid 2 by a process generally called “stripping”.

For example, the stripping gas device 44 is configured to introduce the stripping gas 46 into the inner volume 8 in a gaseous form, in particular without liquid parts or water vapor.

According to another example, the stripping gas device 44 is configured to introduce the stripping gas 46 is a dissolved form, for example along with a liquid or with water vapor.

In the example shown in FIG. 2, the stripping gas device 44 comprises an introduction pipe 48 extending through the outer wall 6 of the separation vessel 4, for example through the lower wall 23, for introducing the stripping gas 46 into the inner volume 8. The stripping gas device 44 may further comprise a set of openings 50 or nozzles configured to disperse the stripping gas 46 in the inner volume 8. The openings 50 are for example positioned at an end of the introduction pipe 48.

According to an example, the stripping gas device 44 is configured to receive at least a part of the stripping gas 46 from the recombinator 34, by a dedicated connection tube, not shown. In this case, the stripping gas 46 is for example hydrogen or nitrogen.

Different features of the above-described embodiments may be combined in any technical feasible manner.

In particular, the degasification system 1 of the nuclear reactor may comprise the sonotrode cluster 16 as described above with reference to the first embodiment in combination with:
the grid structure 40 described with reference to the second embodiment; and/or
the stripping gas device 44 described with reference to the second embodiment for introducing the stripping gas 46 into the inner volume 8; and/or
a tangentially arranged inlet 10 and/or the outlet 12.

The nuclear power plant according to the first and second embodiments described above has a plurality of advantages.

Thanks to the sonotrode cluster 16 comprising at least one sonotrode 24 extending from the outer wall 6 of the separation vessel 4 into the inner volume 8, the degasification system 1 allows a very efficient degasification.

Also, the degasification system 1 is very compact. Thus, the degasification system 1 can be easily integrated in an existing nuclear power plant.

Moreover, the combination of more than one technique for degasification described above allows obtaining synergetic effects. In particular, a combination of several of such techniques together inside the separation vessel 4 results in a better separation efficiency, measured as the amount of gas 18 separated from the gaseous liquid per time unit compared with the operation of the same techniques one after the other, for example in separated installations arranged in a row.

For example, in the second embodiment, the combination of the sonotrode cluster 16 arranged directly inside the separation vessel 4 with the application of a stripping gas 46 by the stripping gas device 44 allows to separate a high quantity of gas 18 from the gaseous liquid 2. A further synergic effect is achieved when the system 1 additionally includes the grid structure 40, because separated gas bubbles bond on the grid structure 40, and thus less or none of the separated gas 18 is dissolved back into the gaseous liquid 2 before being evacuated from the separation vessel 4.

In the first embodiment, the combination of the sonotrode cluster 16 and of the tangential arrangement of the inlet 10 and/or the outlet 12 allows separating and evacuating a particular high amount of gas from the gaseous liquid 2, because the separated gas 18 gathers in the center of the inner volume 8 thanks to the tangential arrangement of the inlet and/or the outlet 12, in order to be evacuated from the separation vessel 4.

An even better result is obtained if the four features mentioned above are combined with each other, i.e.:
the sonotrode cluster 16 as described with reference to the first or second embodiment;
the grid structure 40 described with reference to the second embodiment;
the stripping gas device 44 described with reference to the second embodiment for introducing the stripping gas 46 into the inner volume 8; and
a tangentially arranged inlet 10 and/or the outlet 12.

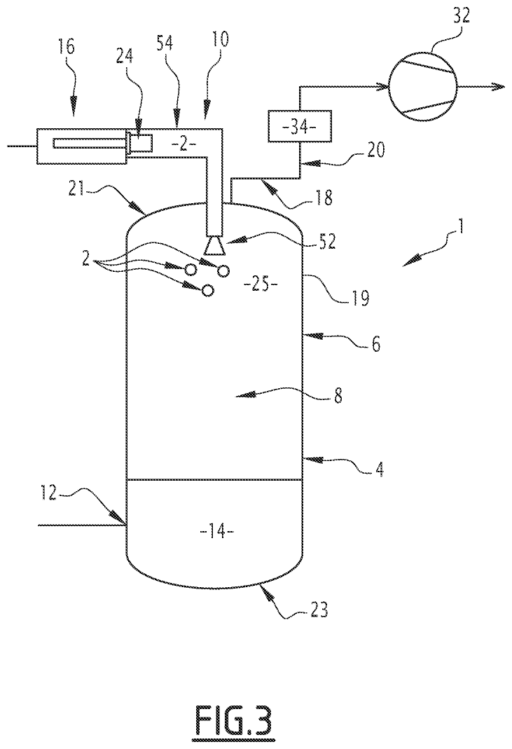

With reference to FIG. 3, a third embodiment of the nuclear power plant comprising the degasification system 1 is shown. The references of the corresponding elements of FIG. 1 are the same. Only the differences are described hereafter.

The inlet 10 for example comprises at least one spray nozzle 52 configured to disperse the gaseous liquid 2 in the form of droplets into the inner volume 8, and more particularly into the gas space. The inlet 10 further comprises an inlet tube 54 extending through the outer wall 6 of the separation vessel 4, for example the upper wall 21. The inlet tube 54 is configured to transport the gaseous liquid 2 to the at least one spray nozzle 52.

A degasification system 1 comprising such an inlet 10 is also called spray type degasification system. The degasification system 1 comprising the inlet 10 having at least one spray nozzle 52 is configured to use the large contact surface between the gas space and the gaseous liquid 2 in form of droplets to release the gas to be separated from the gaseous liquid 2. For example, the gas space is designed to comprise nitrogen.

The gas suction line 20 is configured to evacuate the separated gas 18 from the separation vessel 4, in particular from the gas space 25.

According to an example, the degasification system 1 comprises a gas dryer, not shown, configured to separate humidity such as water from the separated gas 18. For example, the gas dryer is arranged in the suction line 20.

According to a first example of the third embodiment, visible in particular in FIG. 3, the sonotrode cluster 16 comprises at least one sonotrode 24 arranged upstream of the separation vessel 4, for example in the inlet tube 54. The sonotrode cluster 16 is in particular configured to separate gas from the gaseous liquid 2 in micro bubbles, for example as described above. In this case, the inlet 10 having the at least one spray nozzle 52 is in particular configured to introduce the gaseous liquid 2 having micro bubbles into the inner volume 8, such that the gas of the micro bubbles is separated from the gaseous liquid 2.

For example, the separation vessel 4 is designed to receive the degassed liquid 14, or a liquid which is at least partially degassed, in a lower part of the inner volume 8, in particular as a consequence of a degasification of the gaseous liquid 2 intended to take place in the gas space 25 of the separation vessel 4.

The combination of the sonotrode cluster 16, in particular arranged upstream of the separation vessel 4, with the inlet 10 comprising at least one spray nozzle 52 improves the efficiency of degasification. For example, this combination allows separating a high amount of gas per time unit from the gaseous liquid 2, as the gaseous liquid 2 dispersed by the spray nozzle 52 comprises already micro bubbles, and the gas in these bubbles is thus easily and quickly separated from the gaseous liquid 2 and evacuated from the separation vessel 4.

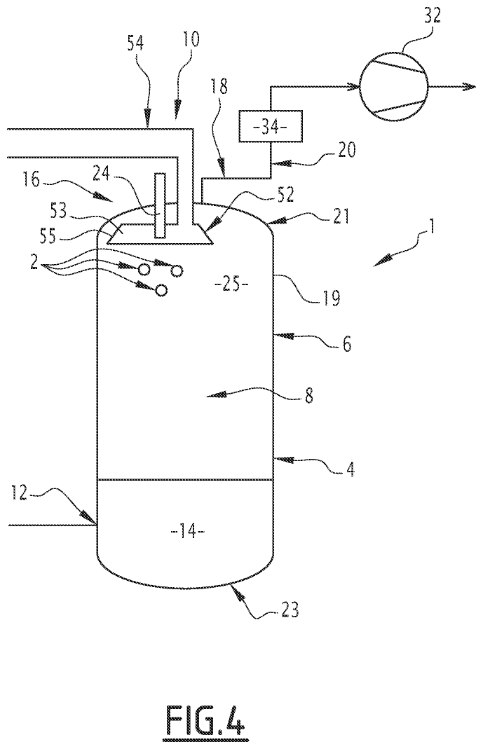

According to a second example of the third embodiment, visible in particular in FIG. 4, the sonotrode cluster 16 comprises at least one sonotrode 24 extending from the outer wall 6 of the separation vessel 4 into the inner volume 8. In particular, the sonotrode cluster 16 comprises at least one sonotrode 24 arranged at least partially inside the spray nozzle 52. For example, the nozzle 52 extends from the upper wall 21 and the sonotrode 24 extends from the upper wall 21 as well. For example, an end of the sonotrode 24 is arranged in an inner space 53 of the spray nozzle 52, in particular of a body 55 of the spray nozzle 52 from which the gaseous liquid 2 is intended to be dispersed in the form of droplets into the inner volume 8.

Thanks to the sonotrode 24 being arranged at least partially inside the spray nozzle 52, gas comprised in the gaseous liquid 2 is separated right before the gaseous liquid 2 is together with the separated gas dispersed in the form of droplets. Thus, less or none of the separated gas 18 is dissolved back into the gaseous liquid 2 before being evacuated from the separation vessel 4.

The person skilled in the art understands that the first and second example of the third embodiment may be combined, so that the sonotrode cluster 16 comprises at least one sonotrode 24 arranged upstream of the separation vessel 4, and at least one sonotrode 24 arranged at least partially inside the spray nozzle 52.

According to a third example of the third embodiment, as visible in particular in figure the sonotrode cluster 16 comprises at least one sonotrode 24 extending from the outer wall 6 of the separation vessel 4 into the inner volume 8. In particular, the sonotrode cluster 16 comprises at least one spray nozzle 52 forming a sonotrode 24 of the sonotrode cluster 16.

According to the third example, the spray nozzle 52 is configured to create ultrasonic vibrations and apply vibrational energy to the gaseous liquid 2 to be dispersed into the inner volume 8 by the spray nozzle 52. The spray nozzle 52 is in particular configured to separate gas comprised in the gaseous liquid 2 in the form of gas bubbles. The spray nozzle 52 is then configured to disperse droplets, comprising a liquid that is at least partially degassed and further comprising the gas bubbles, into the inner volume 8.

For example, the spray nozzle 52 forming the sonotrode 24 comprises at least one piezoelectric transducer 56 and a body 58 of the spray nozzle 52 attached to the piezoelectric transducer 56. The piezoelectric transducer 56 is configured to create ultrasonic vibrations that are transmitted to the body 58 and thus further to the gaseous liquid 2 to be dispersed into the inner volume 8.

For example, the spray nozzle 52 extends from the upper wall 21 at which the gas suction line 20 is arranged. This allows in particular a very small distance between the point from which the droplets are intended to be dispersed into the separation vessel 4, i.e. the spray nozzle 52, and the point of evacuation of the gas from the separation vessel 4, i.e. the gas suction line 20. In particular, thanks to the spray nozzle 52 forming the sonotrode 24, the gas separated from the gaseous liquid 2 is very quickly evacuated from the separation vessel 4.

Furthermore, thanks the spray nozzle 52 forming the sonotrode 24, separated gas bubbles are dispersed together with the liquid in the form of droplets, which increases contact surfaces between the droplets and the gas comprised in the gas space 25. As a consequence, less or none of the separated gas 18 is dissolved back into the gaseous liquid 2 before being evacuated from the separation vessel 4.

The person skilled in the art understands that the first and third example of the third embodiment may be combined, so that the sonotrode cluster 16 comprises at least one sonotrode 24 arranged upstream of the separation vessel 4, and at least one spray nozzle 52 forming a sonotrode 24 of the sonotrode cluster 16.

The skilled person understands that the nuclear power plant according to the third embodiment may comprise one or more features of the nuclear power plant according to the first and/or second embodiment.

For example, in the case in which the separation vessel 4 is designed to receive a liquid which is only partially degassed in a lower part of the inner volume 8, the nuclear power plant according to the third embodiment comprises for example one or more of the following features:
the sonotrode cluster 16 comprises at least one sonotrode 24 extending from the outer wall 6 of the separation vessel 4 into the inner volume 8;
the degasification system 1 comprises the grid structure 40 as described with reference to the second embodiment, in particular arranged in the lower part of the separation vessel 4;
the degasification system 1 comprises the stripping gas device 44 as described with reference to the second embodiment for introducing the stripping gas 46 into the inner volume 8; and/or
the inlet 10 and/or the outlet 12 are arranged tangentially.

The nuclear power plant according to the third embodiment allows for a very efficient degasification. In addition, the degasification system 1 is very compact. Thus, the degasification system 1 can be easily integrated in an existing nuclear power plant.

It is noted that the same advantages as described above with respect to the first and second embodiments are obtained in case the degasification additionally comprises:
the sonotrode cluster 16 according to the first or second embodiment;
the grid structure 40 described with reference to the second embodiment; and/or
the stripping gas device 44 described with reference to the second embodiment for introducing the stripping gas 46 into the inner volume 8; and/or
a tangentially arranged inlet 10 and/or the outlet 12.

Thanks to the sonotrode cluster 16 configured to expose the gaseous liquid 2 to ultrasonic waves combined with the least one inlet 10 comprising at least one spray nozzle 52 configured to disperse the gaseous liquid 2 in the form of droplets into the inner volume 8, the degasification system 1 also allows a very efficient degasification.

Furthermore, the skilled person understands that the nuclear power plant according to the first and/or second embodiment may comprise one or more features of the nuclear power plant according to the third embodiment.

For example, in the nuclear power plant according to the first and/or second embodiment, the inlet 10 comprises the at least one spray nozzle 52 configured to disperse the gaseous liquid 2 in the form of droplets into the inner volume 8.

For example, the spray nozzle 52 in the first and/or second embodiment may comprise any of the features described above. As an example, the at least one sonotrode 24 is arranged at least partially inside the spray nozzle 52. According to an alternative, the spray nozzle 52 forms the at least one sonotrode 24.

1-19. (canceled)

20. A nuclear power plant comprising a system for degasification of a gaseous liquid, the system comprising:
a separation vessel having at least one outer wall delimiting an inner volume and configured for separating gas from the gaseous liquid;
at least one inlet adapted to introduce the gaseous liquid into the inner volume;
at least one gas suction line attached to the separation vessel and being adapted to discharge the separated gas from the inner volume;
at least one outlet adapted to discharge a degassed liquid from the inner volume; and
a sonotrode cluster configured to expose the gaseous liquid to ultrasonic waves;
the sonotrode cluster comprising at least one sonotrode extending from the outer wall of the separation vessel into the inner volume.

21. The nuclear power plant according to claim 20, wherein the gaseous liquid comprises water and at least one gas and related nuclides, the gas being chosen from a group consisting of:
hydrogen;
oxygen;
nitrogen;
xenon; and
krypton.

22. The nuclear power plant according to claim 20, further comprising a primary reactor coolant circuit and a secondary reactor coolant circuit, at least the inlet being fluidically connected to the primary reactor coolant circuit or to the secondary reactor coolant circuit.

23. The nuclear power plant according to claim 20, wherein the at least one sonotrode extends perpendicularly relative to the outer wall from the outer wall into the inner volume.

24. The nuclear power plant according to claim 20, wherein the outer wall comprises a lateral wall, and comprises furthermore an upper wall and a lower wall connected by the lateral wall.

25. The nuclear power plant according to claim 24, wherein the at least one sonotrode extends from the lateral wall.

26. The nuclear power plant according to claim 24, wherein the inlet and the outlet are arranged tangentially with respect to the lateral wall of the separation vessel so as to generate a centrifugal flow of the gaseous liquid in the separation vessel.

27. The nuclear power plant according claim 20, wherein the inlet comprises at least one spray nozzle configured to disperse the gaseous liquid in the form of droplets into the inner volume.

28. The nuclear power plant according to claim 27, wherein the at least one sonotrode is arranged at least partially inside the spray nozzle.

29. The nuclear power plant according to claim 27, wherein the at least one spray nozzle forms the at least one sonotrode.

30. The nuclear power plant according to claim 20, wherein the degasification system comprises a grid structure arranged in the inner volume of the separation vessel.

31. The nuclear power plant according to claim 20, wherein the degasification system comprises a stripping gas device configured for introducing a stripping gas into the inner volume.

32. The nuclear power plant according to claim 20, wherein the degasification system comprises a recombinator configured to receive the separated gas, and to reintroduce at least a part of the separated gas into the separation vessel, for example combined with another gas.

33. The nuclear power plant according to claim 20, wherein the sonotrode cluster is arranged such that the gaseous liquid in the inner volume is penetrated homogenously.

34. A nuclear power plant comprising a system for degasification of a gaseous liquid, the system comprising:
a separation vessel having at least one outer wall delimiting an inner volume;
at least one inlet adapted to introduce the gaseous liquid into the inner volume;
at least one gas suction line attached to the separation vessel and being adapted to discharge separated gas from the inner volume; and
at least one outlet adapted to discharge a degassed liquid from the inner volume; and
a sonotrode cluster configured to expose the gaseous liquid to ultrasonic waves,
the at least one inlet comprising at least one spray nozzle configured to disperse the gaseous liquid in the form of droplets into the inner volume.

35. The nuclear power plant according to claim 34, wherein the sonotrode cluster comprises at least one sonotrode arranged upstream of the separation vessel.

36. The nuclear power plant according to claim 34, wherein the sonotrode cluster comprises at least one sonotrode extending from the outer wall of the separation vessel into the inner volume.

37. The nuclear power plant according to claim 36, wherein the at least one sonotrode extending from the outer wall of the separation vessel is arranged at least partially inside the spray nozzle.

38. The nuclear power plant according to claim 36, wherein the at least one spray nozzle forms the at least one sonotrode extending from the outer wall of the separation vessel.
